(19) United States
(12) Patent Application Publication
(10) Pub. No.: US 2014/0000056 A1
(43) Pub. Date: Jan. 2, 2014

(54) WIPER DEVICE, IN PARTICULAR MOTOR VEHICLE WINDSHIELD WIPER DEVICE

(71) Applicants: Hervé Bratec, Wilsele (BE); Mohamed Aznag, Scherpenheuvel-Zichem (BE); Godelieve Kraemer, Huegelsheim (DE); Sven Wolfgarten, Buehl (DE); Harald Rapp, Buehl (DE)

(72) Inventors: Hervé Bratec, Wilsele (BE); Mohamed Aznag, Scherpenheuvel-Zichem (BE); Godelieve Kraemer, Huegelsheim (DE); Sven Wolfgarten, Buehl (DE); Harald Rapp, Buehl (DE)

(73) Assignee: Robert Bosch GmbH, Stuttgart (DE)

(21) Appl. No.: 13/976,878

(22) PCT Filed: Nov. 22, 2011
(86) PCT No.: PCT/EP2011/070673

§ 371 Date: Sep. 10, 2013

(30) Foreign Application Priority Data
Dec. 27, 2010 (DE) 10 2010 064 170.7

(51) Int. Cl. B60S 1/40

(52) U.S. Cl. CPC B60S 1/4041
USPC 15/250.32

(57) ABSTRACT

The invention relates to a wiper device, in particular a motor vehicle windshield wiper device, having a wiper blade adapter (10a-10f) and a wiper arm adapter (12a-12f) which can be mounted on the wiper blade adapter (10a-10f). According to the invention, the wiper blade adapter (10a-10f) has at least two side walls (14a-14f, 16a-16f), which delimit a receiving region (18a-18f) for the wiper arm adapter (12a-12f) in a wiping direction (20a-20f), and a rotational joint unit (22a-22f) of the wiper blade adapter (10a-10f) is arranged inside the receiving region (18a-18f), said unit bearing the wiper arm adapter (12a-12f) in a mounted state.

### BACKGROUND OF THE INVENTION

A wiper device, in particular a motor vehicle windshield wiper device, having a wiper blade adapter and a wiper arm adapter that is assemblable on the wiper blade adapter is already known.

### SUMMARY OF THE INVENTION

The invention proceeds from a wiper device, in particular a motor vehicle windshield wiper device, having a wiper blade adapter and a wiper arm adapter that is assemblable on the wiper blade adapter.

It is proposed that the wiper blade adapter has at least two side walls which bound a receiving region for the wiper arm adapter in a wiping direction, and that a rotary joint unit of the wiper blade adapter is arranged within the receiving region, said rotary joint unit mounting the wiper arm adapter in an assembled state, with the result that a particularly compact design of the wiper device and/or a small overall height of the wiper device can be achieved. In this connection, a “wiper blade adapter” should be understood to mean in particular an adapter which is intended to provide a coupling region of the wiper blade device for coupling to a wiper arm. In this connection, a “wiper arm adapter” should be understood to mean in particular an adapter which has a contact region with a wiper arm component, is connected captively to the wiper arm component and is intended to provide a coupling region of the wiper arm component for coupling to and/or contact with the wiper blade adapter. In this connection, a “wiping direction” should be understood to mean in particular a direction in which the wiper device, in at least one operating state, is moved in relation to a motor vehicle window which is wiped by the wiping device. Preferably, the wiping direction extends at least substantially perpendicularly to a longitudinal extent of the wiper arm adapter and/or parallel to the motor vehicle window. In this connection, “substantially” should be understood to mean in particular a deviation of less than 20°, preferably less than 10°. In this connection, a “longitudinal extent” should be understood to mean in particular a largest possible extent. In this connection, an “extent” of an element should be understood to mean in particular a maximum distance between two points of a perpendicular projection of the element to a plane. In this connection, “bound” should be understood to mean in particular close off and/or surround. In this connection, a “rotary joint unit” should be understood to mean in particular a unit which is intended to mount at least two components in a rotatable manner with respect to one another. In this case, at least one component preferably engages in a form-fitting manner around the further component. “Intended” should be understood to mean in particular specially designed and/or equipped.

In a further configuration of the invention, it is proposed that, in the assembled state, the wiper arm adapter rests against at least one bearing surface of the rotary joint unit, with the result that particularly easy mounting of the wiper arm adapter with the wiper blade adapter can be achieved and further components can advantageously be avoided. In this connection, a “bearing surface” should be understood to mean in particular a surface facing toward a component to be mounted, said surface being intended to support bearing forces. Preferably, the bearing surface is a plain bearing surface which is intended to guide the component to be mounted.

It is furthermore proposed that the bearing surface is formed by at least one rotary joint pin of the rotary joint unit, with the result that costs and/or material can easily be saved. In this connection, a “rotary joint pin” should be understood to mean in particular a body which has a convexly formed bearing surface and/or a plain bearing surface. Preferably, it is a cylindrical body.

If, in the assembled state, the wiper arm adapter forms a form fit at least in a vertical direction with the rotary joint unit, secure mounting of the wiper blade adapter can be achieved, with additional components being avoided. In this connection, a “vertical direction” should be understood to mean in particular a direction directed away from a coupling region of the wiper blade adapter. Preferably, in an operating state, the vertical direction is at least substantially perpendicular to the motor vehicle window to be wiped.

Furthermore, it is proposed that the wiper arm adapter has a latching means which is intended to form a latching connection with the wiper blade adapter in the assembled state, with the result that the wiper arm adapter can be assembled particularly quickly on the wiper blade adapter. In this connection, a “latching means” should be understood to mean in particular a resiliently elastic means for producing a latching connection, said means being intended to be elastically deflected during assembly.

It is furthermore proposed that the wiper device has a longitudinal fixing element which is formed separately from the rotary joint unit, said longitudinal fixing element being intended to absorb, at least in a longitudinal direction, a force component that occurs between the wiper blade adapter and the wiper arm adapter, with the result that the wiper device can be formed in a particularly stable manner.

In a further configuration of the invention, it is proposed that the wiper arm adapter has a fastening recess which is intended to form a form fit with the longitudinal fixing element in the assembled state, with the result that the wiper arm adapter can be secured easily and stably to the wiper blade adapter. In this connection a “longitudinal fixing element” should be understood to mean in particular an element which is intended to limit the freedom of movement of the component at least in the longitudinal direction. Preferably, the longitudinal fixing element is formed in one piece with a main body of the wiper blade adapter. “In one piece” should be understood in particular to mean cohesively connected, for example by way of a welding process and/or adhesive-bonding process etc., and particularly advantageously integrally formed, such as by means of production by casting and/or by a single-component or multi-component injection-molding process.

If the rotary joint pin is designed to be detachable from a main body of the wiper blade adapter, the wiper arm adapter can be assembled particularly easily on the wiper blade adapter. In this connection, “detachable” should be understood to mean in particular “non-destructively separable”. Particularly advantageously, the rotary joint pin is detachable and/or fastenable without tools.

### BRIEF DESCRIPTION OF THE DRAWINGS

Further advantages can be found in the following description of the drawing. The drawing illustrates exemplary embodiments of the invention. The drawings, the description and the claims contain numerous features in combination. A person skilled in the art will also expediently consider the features individually and combine them to form meaningful further combinations.

In the drawing:

FIG. 1 shows a perspective view of a wiper device having a wiper blade and a wiper arm,

FIG. 2 shows a perspective view of the wiper device according to FIG. 1 in an opened state,

FIGS. 3a and 3b show a sectional illustration of the wiper device according to FIG. 1 in an assembly sequence,

FIG. 4 shows a perspective view of a further exemplary embodiment of a wiper device,

FIG. 5 shows a sectional illustration of the wiper device according to FIG. 4 in an assembled state,

FIG. 6 shows a perspective view of a further exemplary embodiment of a wiper device,

FIGS. 7a and 7b show a sectional illustration of the wiper device according to FIG. 6 in an assembly sequence,

FIG. 8 shows a perspective view of a further exemplary embodiment of a wiper device in a first assembly step,

FIG. 9 shows a perspective view of the wiper device according to FIG. 8 in an assembled state,

FIG. 10 shows a sectional illustration of the wiper device according to FIG. 8 in an assembled state,

FIG. 11 shows a perspective view of a further exemplary embodiment of a wiper device,

FIGS. 12a and 12b show a sectional illustration of the wiper device according to FIG. 11 in an assembly sequence,

FIG. 13 shows a perspective view of a further exemplary embodiment of a wiper device, and

FIGS. 14a and 14b show a side view of the wiper device according to FIG. 13 in an assembly sequence.

### DETAILED DESCRIPTION

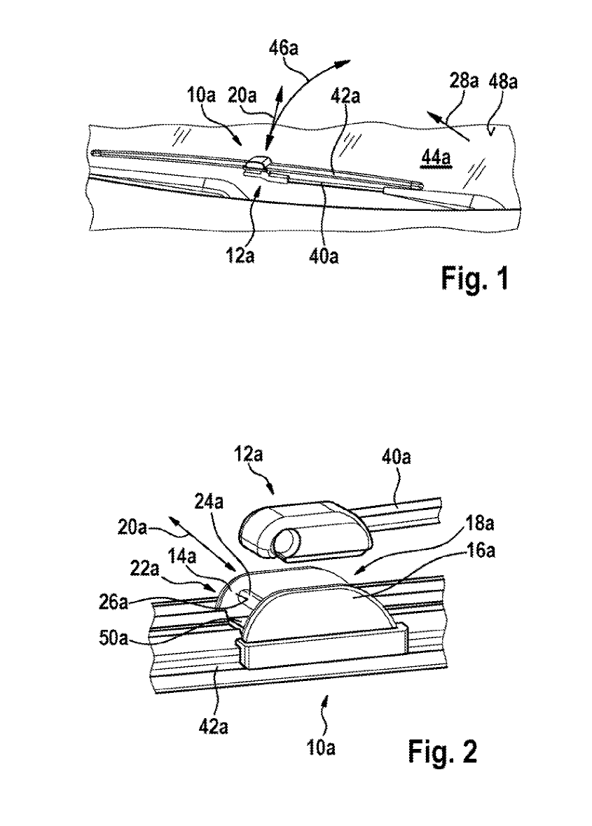

FIG. 1 shows a perspective view of a wiper device for a motor vehicle, having a wiper blade adapter 10a and a wiper arm adapter 12a assembled on the wiper blade adapter 10a, said wiper arm adapter 12a being fastened to a wiper arm 40a. Fastened to the wiper blade adapter 10a is a wiper blade 42a which rests on a motor vehicle window 44a to be wiped. In an operating state, the wiper blade adapter 10a and the wiper arm adapter 12a move from a shown starting position on a circular path 46a over the motor vehicle window 44a. The movement is shown by a wiping direction 20a tangential to the circular path 46a. A vertical direction 28a is in this case perpendicular to a surface 48a to be wiped of the motor vehicle window 44a in a region of the wiper blade adapter 10a.

The wiper blade adapter 10a provides a coupling region of the wiper blade device for coupling to the wiper arm 40a. The wiper arm adapter 12a provides a coupling region of the wiper arm 40a for coupling to and contact with the wiper blade adapter 10a.

FIG. 2 shows a detail view of the wiper device with the wiper blade adapter 10a and the wiper arm adapter 12a that is assemblable on the wiper blade adapter 10a, in an opened state. The wiper arm adapter 12a is connected non-detachably and rigidly to the wiper arm 40a. The wiper blade adapter 10a is connected rigidly to the wiper blade 42a in a rotationally conjoint manner.

The wiper blade adapter 10a has two side walls 14a, 16a which are arranged parallel to one another. The side walls 14a, 16a are in this case oriented perpendicularly to the wiping direction 20a. A receiving region 18a is bounded by the side walls 14a, 16a in the wiping direction 20a.

Within the receiving region 18a there is arranged a rotary joint unit 22a having a rotary joint pin 24a which is formed by a cylindrical body. The rotary joint pin 24a is formed in one piece with the side walls 14a, 16a. The side walls 14a, 16a form, together with a base plate 50a, a main body 38a of the wiper blade adapter 10a.

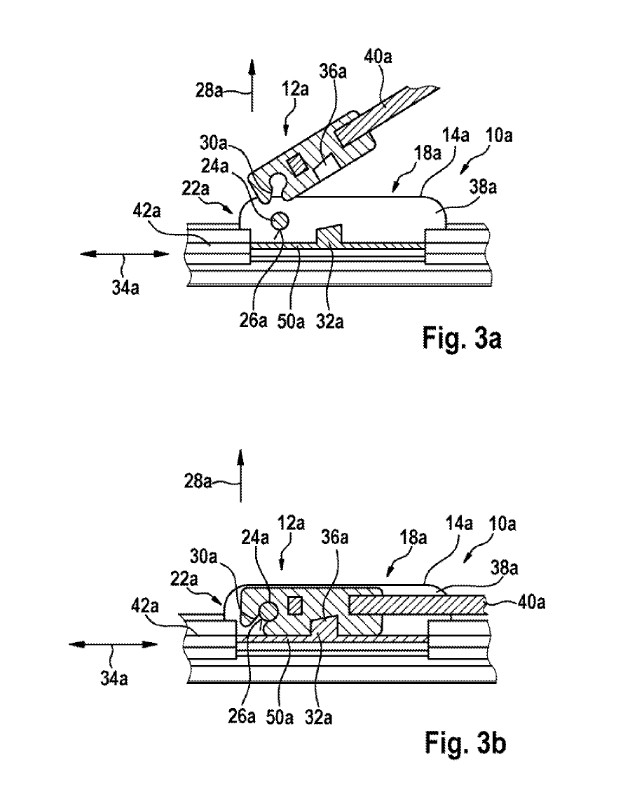

FIG. 3a shows the wiper device in a first assembly step. The wiper arm adapter 12a is detached from the wiper blade adapter 10a. The wiper arm adapter 12a has a latching means 30a which is in the form of a C-shaped receiving body. The rotary joint pin 24a forms a bearing surface 26a for rotatably mounting the wiper arm adapter 12a.

FIG. 3b shows the wiper device in an assembled state. The wiper arm adapter 12a rests against the bearing surface 26a of the rotary joint unit 22a. The bearing surface 26a is curved convexly toward the latching means 30a. Via the rotary joint unit 22a, the latching means 30a forms a latching connection with the wiper blade adapter 10a. In this case, the latching means 30a engages in a form-fitting manner around the rotary joint pin 24a. As a result, the wiper arm adapter 12a forms a form fit in the vertical direction 28a with the rotary joint unit 22a in an assembled state. A movement of the wiper arm adapter 12a in relation to the wiper blade adapter 10a in the vertical direction 28a is thus avoided.

The wiper blade adapter 10a furthermore has a longitudinal fixing element 32a which is formed separately from the rotary joint unit 22a and is formed in one piece with the main body 38a. The longitudinal fixing element 32a absorbs a force component, occurring in the longitudinal direction 34a, of a force which occurs between the wiper blade adapter 10a and the wiper arm adapter 12a in an operating state. The wiper arm adapter 12a has a fastening recess 36a in which the longitudinal fixing element 32a engages in a form-fitting manner by way of a rotation of the wiper blade adapter 10a in relation to the wiper arm adapter 12a. The rotation takes place in this case about an axis which extends parallel to the wiping direction 20a.

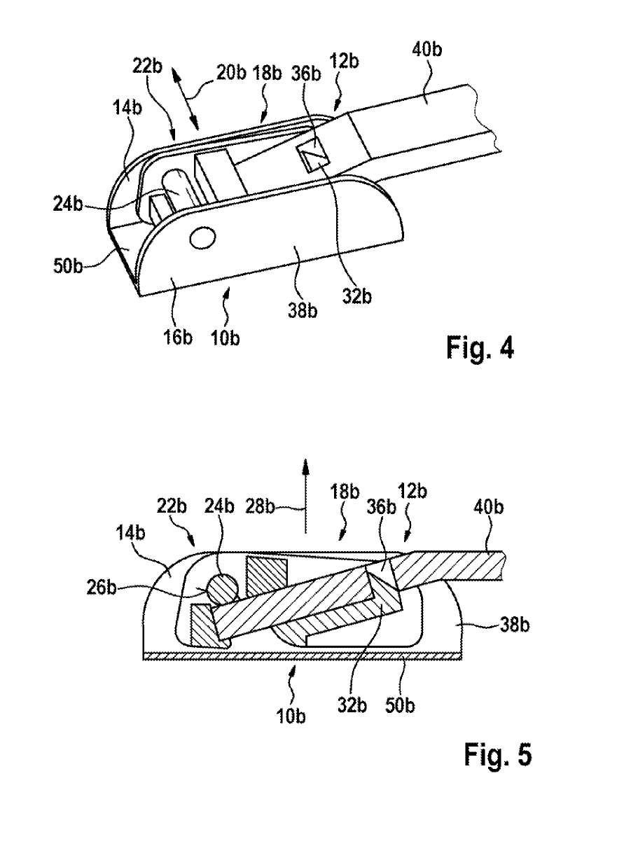

FIGS. 4 to 14 show five further exemplary embodiments of the invention. The following descriptions are limited substantially to the differences between the exemplary embodiments, it being possible to refer to the description of the first exemplary embodiment with regard to components, features and functions that remain the same. In order to distinguish between the exemplary embodiments, the letter a in the reference signs of the exemplary embodiment in FIGS. 1 to 3 is replaced by the letters b to fin the reference signs of the exemplary embodiments in FIGS. 4 to 14. With regard to identically denoted components, in particular with regard to components having the same reference signs, reference can be made in principle to the drawings and/or the description of the first exemplary embodiment.

FIG. 4 shows a perspective view of a further exemplary embodiment of a wiper device having a wiper blade adapter 10b and a wiper arm adapter 12b in an assembled state. The wiper arm adapter 12b is formed in one piece with a wiper arm 40b.

The wiper arm adapter 12b has a rectangular fastening recess 36b. A longitudinal fixing element 32b engages in a form-fitting manner in the fastening recess 36b. Two side walls 14b, 16b of the wiper blade adapter 10b adjoin a receiving region 18b of the wiper blade adapter 10b. The side walls 14b, 16b extend perpendicularly to a wiping direction 20b.

Within the receiving region 18b there is arranged a rotary joint unit 22b having a rotary joint pin 24b which is formed by a cylindrical body. The rotary joint pin 24b is formed in one piece with the side walls 14b, 16b. The side walls 14b, 16b form, together with a base plate 50b, a main body 38b of the wiper blade adapter 10b.

FIG. 5 further shows a sectional illustration of the wiper device. The wiper arm adapter 12b rests against a bearing surface 26b of the rotary joint unit 22b. The bearing surface 26b is curved convexly toward the wiper arm adapter 12b. The wiper arm adapter 12b forms a form fit in a vertical direction 28b with the rotary joint unit 22b. A movement of the wiper arm adapter 12b in relation to the wiper blade adapter 10b in the vertical direction 28b is thus avoided.

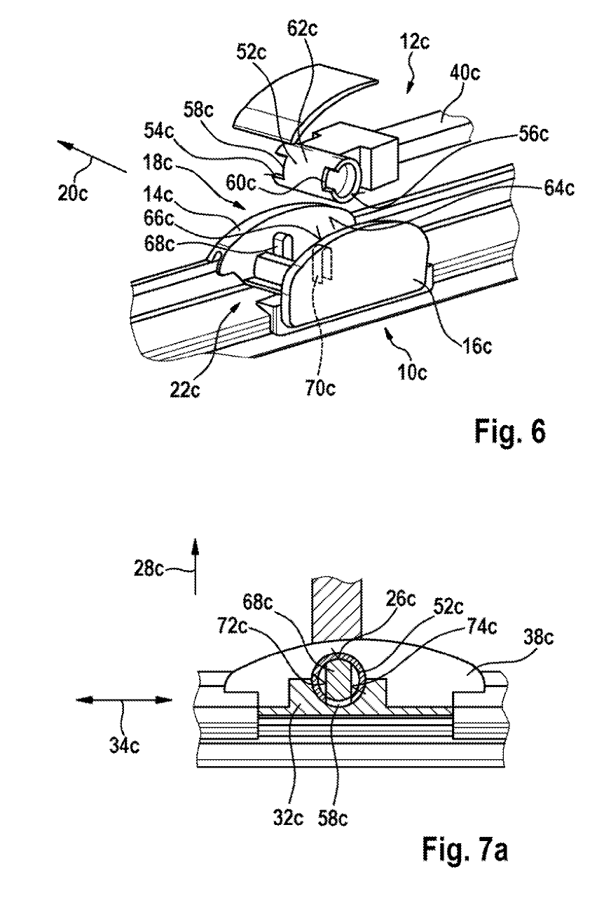

FIG. 6 shows a further exemplary embodiment of a wiper device having a wiper blade adapter 10c and a wiper arm adapter 12c. The wiper arm adapter 12c is fastened rigidly to a wiper arm 40c and has a fastening means 52c which is in the form of a hollow cylinder. On two main surfaces 54c, 56c of the fastening means 52c, a groove-shaped fastening recess 58c, 60c is let in each case into a lateral surface 62c of the fastening means 52c.

Two side walls 14c, 16c of the wiper blade adapter 10c adjoin a receiving region 18c of the wiper blade adapter 10c. The side walls 14c, 16c extend perpendicularly to a wiping direction 20c. A rotary joint pin 68c, 70c of a rotary joint unit 22c is arranged in each case on mutually facing inner surfaces 64c, 66c of the side walls 14c, 16c, said rotary joint pin 68c, 70c being formed in one piece with the side walls 14c, 16c.

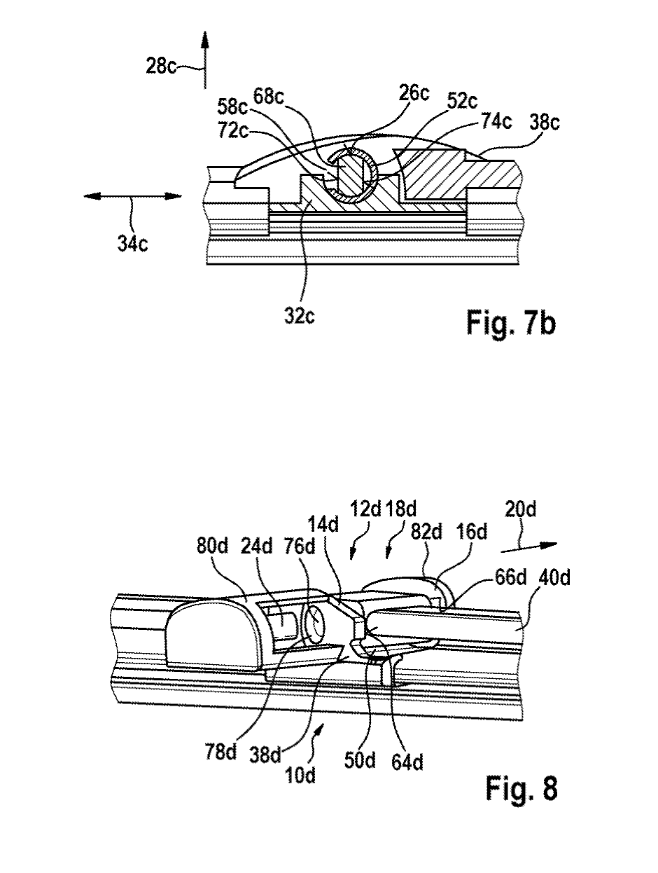

FIG. 7a shows a first assembly step of the wiper device. The rotary joint pins 68c, 70c have a convexly curved bearing surface 26c, the radius of curvature of which corresponds to an inner radius of the hollow-cylindrical fastening means 52c. Furthermore, the rotary joint pins 68c, 70c have two guide surfaces 72c, 74c which extend perpendicularly to a longitudinal direction 34c.

The fastening recesses 58c, 60c are guided via the guide surfaces 72c, 74c. The fastening means 52c rests on a longitudinal fixing element 32c which is formed in one piece with a main body 38c of the wiper blade adapter 10c. The longitudinal fixing element 32c has a concavely curved bearing surface, the radius of curvature of which corresponds to an outer radius of the fastening means 52c.

As a result of the rotation of the wiper arm adapter 12c in relation to the wiper blade adapter 10c, the wiper arm adapter 12c rests with the fastening means 52c against the bearing surface 26c of the rotary joint unit 22c (FIG. 7b). The wiper arm adapter 12c thus forms a form fit in a vertical direction 28c with the rotary joint unit 22c. A movement of the wiper arm adapter 12c in relation to the wiper blade adapter 10c in the vertical direction 28c is thus avoided. The lateral surface 62c rests against the longitudinal fixing element 32c, with the result that a movement of the wiper arm adapter 12c in relation to the wiper blade adapter 10c in the longitudinal direction 34c is avoided.

FIG. 8 shows a further exemplary embodiment of a wiper device having a wiper blade adapter 10d and a wiper arm adapter 12d in a first assembly step. The wiper arm adapter 12d is fastened rigidly to a wiper arm 40d and has a circular continuous bearing recess 76d. Two side walls 14d, 16d of the wiper blade adapter 10d bound a receiving region 18d of the wiper blade adapter 10d.

The side walls 14d, 16d extend perpendicularly to a wiping direction 20d. Furthermore, the side walls 14d, 16d are formed in one piece with a base plate 50d and form with the latter a main body 38d of the wiper blade adapter 10d. A further continuous bearing recess 78d is arranged in each case on mutually facing inner surfaces 64d, 66d of the side walls 14d, 16d.

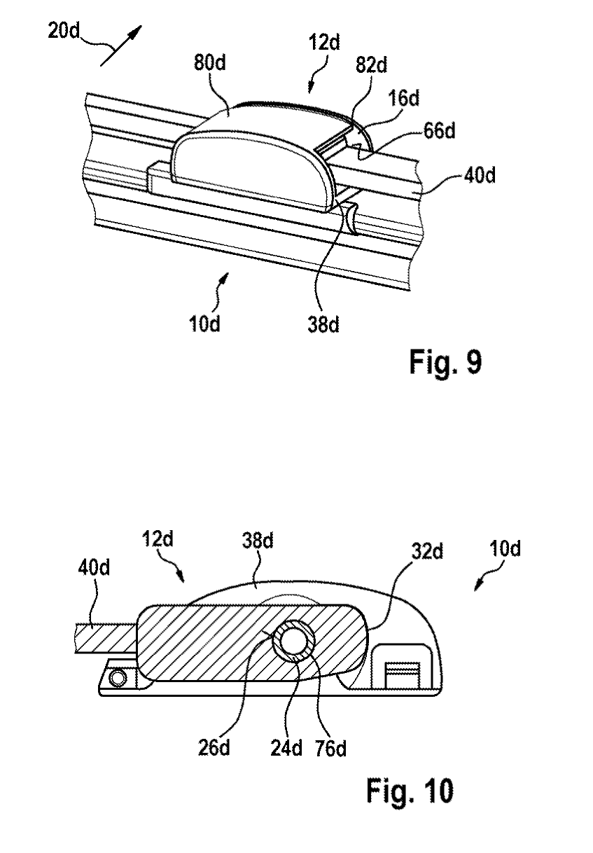

A cap element 80d formed separately from the wiper blade adapter 10d has a rotary joint pin 24d. The rotary joint pin 24d is introduced in a form-fitting manner into the bearing recesses 76d, 78d for assembly purposes (FIG. 9). The cap element 80d terminates flush with a top edge 82d of the side wall 16d.

As is furthermore shown in FIG. 10, the rotary joint pin 24d has a convexly curved bearing surface 26d, the radius of curvature of which is the same as an inner radius of the bearing recess 76d. As a result, the wiper blade adapter 10d is connected to the wiper arm adapter 12d so as to be mounted in a rotatable manner.

The rotary joint pin 24d is in this case formed to be detachable from the main body 38d of the wiper blade adapter 10d and is non-destructively separable therefrom. For the purposes of disassembly, the rotary joint pin 24d can be detached without tools. A longitudinal fixing element 32d is formed in one piece with the cap element 80d. In the assembled state shown, the wiper arm adapter 12d rests against the longitudinal fixing element 32d. The longitudinal fixing element 32d has in this case a concavely curved bearing surface.

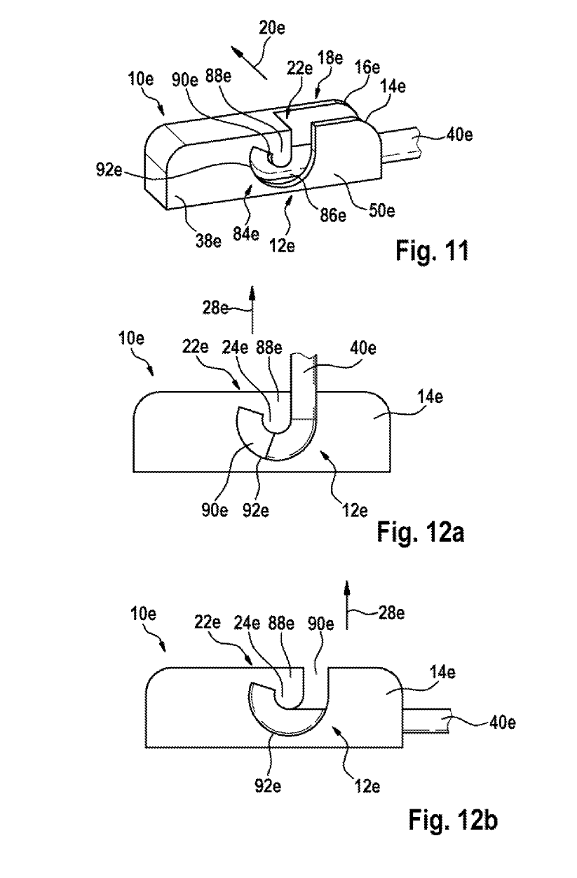

FIG. 11 shows a further exemplary embodiment of a wiper device for a motor vehicle, having a wiper blade adapter 10e and a wiper arm adapter 12e that is assembled on the wiper blade adapter 10e and is formed in one piece with a wiper arm 40e. The wiper arm adapter 12e has the same cross section as the wiper arm 40e. In an end region 84e of the wiper arm adapter 12e, the latter has a bend 86e. The wiper blade adapter 10e is fastenable to a wiper blade (not illustrated).

The wiper blade adapter 10e has two side walls 14e, 16e which are arranged parallel to one another. The side walls 14e, 16e are oriented in this case perpendicularly to a wiping direction 20e. A receiving region 18e is bounded by side walls 14e, 16e in the wiping direction 20e.

Within the receiving region 18e there is arranged a rotary joint unit 22e having a rotary joint pin 24e which is formed with the side walls 14e, 16e. The side walls 14e, 16e form, with a base plate 50e and an intermediate body 88e which is formed in one piece with the side walls 14e, 16e, a main body 38e of the wiper blade adapter 10e. A slotted guide 90e is let into the intermediate body 88e. The slotted guide 90e has a bend 92e which has the same radius of curvature as the bend 86e of the wiper arm adapter 12e.

During assembly, the wiper arm adapter 12e is pushed in a form-fitting manner into the slotted guide 90e (FIG. 12a). On account of the bend 92e of the slotted guide 90e, a rotation of the wiper arm adapter 12e in relation to the wiper blade adapter 10e is necessary during assembly.

In the exemplary embodiment shown, the wiper arm adapter 12e is rotated through 90° in relation to the wiper blade adapter 10e and in the process engages around the rotary joint pin 24e or parts of the intermediate body 88e (FIG. 12b). The rotation takes place in this case about an axis which extends parallel to the wiping direction 20e. As a result, the wiper arm adapter 12e forms a form fit in a vertical direction 28e with the rotary joint unit 22e in an assembled state. A movement of the wiper arm adapter 12e in relation to the wiper blade adapter 10e in the vertical direction 28e is avoided. In the wiping direction 20e, the side walls 14e, 16e avoid a movement of the wiper arm adapter 12e in relation to the wiper blade adapter 10e.

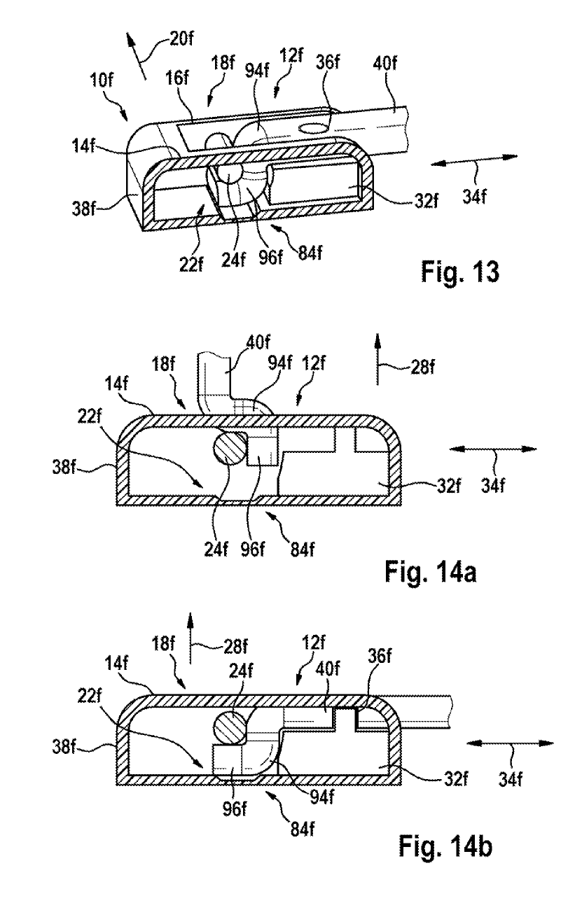

FIG. 13 shows a further exemplary embodiment of a wiper device for a motor vehicle, having a wiper blade adapter 10f and a wiper arm adapter 12f which is assembled on the wiper blade adapter 10f and is formed in one piece with a wiper arm 40f. The wiper arm adapter 12f has the same cross section as the wiper arm 40f. In an end region 84f of the wiper arm adapter 12f, the latter has a first bend 94f and a second bend 96f. The first and second bends 94f, 96f form an S-shaped profile. The wiper blade adapter 10f is fastenable to a wiper blade (not illustrated).

The wiper blade adapter 10f has two side walls 14f, 16f which are arranged parallel to one another. The side walls 14f, 16f are oriented in this case perpendicularly to a wiping direction 20f. A receiving region 18f is bounded by side walls 14f, 16f in the wiping direction 20f.

Within the receiving region 18f there is arranged a rotary joint unit 22f having a rotary joint pin 24f which is formed in one piece with the side walls 14f, 16f. The side walls 14f, 16f form, with a base plate 50f, a main body 38f of the wiper blade adapter 10f.

The wiper blade adapter 10f furthermore has a longitudinal fixing element 32f which is formed separately from the rotary joint unit 22f and is formed in one piece with the main body 38f. The longitudinal fixing element 32f absorbs a force component, occurring in the longitudinal direction 34f, of a force which occurs between the wiper blade adapter 10f and the wiper arm adapter 12f in an operating state.

The wiper arm adapter 12f has a fastening recess 36f into which the longitudinal fixing element 32f engages in a form-fitting manner by way of a rotation of the wiper blade adapter 10f in relation to the wiper arm adapter 12f. The rotation takes place in this case about an axis which extends parallel to the wiping direction 20f.

During assembly, the wiper arm adapter 12f is placed on the rotary joint pin 24f in a region of the second bend 96f (FIG. 14a). In the event of a rotation of the wiper arm adapter 12f through 90° in relation to the wiper blade adapter 10f, the wiper arm adapter 12f engages around the rotary joint pin 24f (FIG. 14b). The rotation takes place in this case about an axis which extends parallel to a wiping direction 20f. As a result, the wiper arm adapter 12f forms a form fit in a vertical direction 28f with the rotary joint unit 22f in an assembled state. A movement of the wiper arm adapter 12f in relation to the wiper blade adapter 10f in the vertical direction 28f is avoided. In the wiping direction 20f, the side walls 14f, 16f avoid a movement of the wiper arm adapter 12f in relation to the wiper blade adapter 10f.

1. A wiper device, having a wiper blade adapter (10a-10f) and a wiper arm adapter (12a-12f) that is assemblable on the wiper blade adapter (10a-10f), characterized in that the wiper blade adapter (10a-10f) has at least two side walls (14a-14f, 16a-16f) which bound a receiving region (18a-18f) for the wiper arm adapter (12a-12f) in a wiping direction (20a-20f), and in that a rotary joint unit (22a-22f) of the wiper blade adapter (10a-10f) is arranged within the receiving region (18a-18f), said rotary joint unit (22a-22f) mounting the wiper arm adapter (12a-12f) in an assembled state.

2. The wiper device as claimed in claim 1, characterized in that, in the assembled state, the wiper arm adapter (12a-12d) rests against at least one bearing surface (26a-26d) of the rotary joint unit (22a-22d).

3. The wiper device as claimed in claim 2, characterized in that the bearing surface (26a-26d) is formed by at least one rotary joint pin (24a-24d) of the rotary joint unit (22a-22d).

4. The wiper device as claimed in claim 1, characterized in that, in the assembled state, the wiper arm adapter (12a-12f) forms a form fit at least in a vertical direction (28a-28f) with the rotary joint unit (22a-22f).

5. The wiper device as claimed in claim 1, characterized in that the wiper arm adapter (12a) has a latching means (30a) forming a latching connection with the wiper blade adapter (10a) in the assembled state.

6. The wiper device as claimed in claim 1, characterized by a longitudinal fixing element (32a-32f) which is formed separately from the rotary joint unit (22a-22f), said longitudinal fixing element (32a-32f) absorbing, at least in a longitudinal direction (34a-34f), a force component that occurs between the wiper blade adapter (10a-10f) and the wiper arm adapter (12a-12f).

7. The wiper device as claimed in claim 6, characterized in that the wiper arm adapter (12a; 12b; 12f) has a fastening recess (36a; 36b; 36f) forming a form fit with the longitudinal fixing element (32a; 32b; 32f) in the assembled state.

8. The wiper device at least as claimed in claim 3, characterized in that the rotary joint pin (24d) is detachable from a main body (38d) of the wiper blade adapter (10d).

9. A wiper blade adapter (10a-10f) of a wiper device as claimed in claim 1.

10. A wiper arm adapter (12a-12f) of a wiper device as claimed in claim 1.
